(19) United States
(12) Patent Application Publication
(10) Pub. No.: US 2013/0144537 A1
(43) Pub. Date: Jun. 6, 2013

(54) Real Time Assessment During Interactive Activity

(71) Applicant: Neuro Analytics and Technologies, LLC, Princeton, NJ (US)

(72) Inventors: Gerwin Schalk, Glenmont, NY (US); Sean Paul Austin, Saratoga Springs, NY (US)

(73) Assignee: Neuro Analytics and Technologies, LLC, Princeton, NJ (US)

(21) Appl. No.: 13/692,223

(22) Filed: Dec. 3, 2012

Related U.S. Application Data
(60) Provisional application No. 61/566,636, filed on Dec. 3, 2011.

(51) Int. Cl. G06F 15/00

(52) U.S. Cl. CPC G06F 15/00
USPC 702/19; 702/127

(57) ABSTRACT

A solution for adjusting an interactive activity is provided. While a person is engaged in an instance of the interactive activity, direct measurement data corresponding to the person is received. The direct measurement data is used to assess at least one aspect of a response of the person to the instance of the interactive activity. Assessment data corresponding to the at least one aspect of the response is provided for use in adjusting at least one aspect of the interactive activity.

### REFERENCE TO RELATED APPLICATIONS

The current application claims the benefit of co-pending U.S. Provisional Application No. 61/566,636, titled “Real Time Assessment During Interactive Activity,” which was filed on 3 Dec. 2011, and which is hereby incorporated by reference.

### TECHNICAL FIELD

The disclosure relates generally to interactive activities, and more particularly, to a solution for generating real time assessment data for one or more attributes of one or more people while each person is engaged in the interactive activity.

### BACKGROUND ART

There are many different types of interactive activities. These include computer games, other interactive media such as interactive movies, or different types of tests. At present, the parameters of these activities, such as the difficulty of a computer game or test, are usually relatively fixed. Current processes for optimizing these activities for a particular purpose are typically indirect and subjective. For example, to maximize the engagement of a person playing a computer game, existing methods may subject the player to traditional testing instruments, such as questionnaires, which the player is asked to complete after the computer game is completed.

Such traditional methods are indirect, because they depend on a person's memory of the activity. This is because these methods cannot perform assessments concurrently with, but only after, any particular point in the activity. They are also subjective, because they depend on the person's interpretation of the particular characteristic that is to be assessed (e.g., joy, engagement, difficulty, etc.). Thus, the measurements of the characteristics of the subject that are resulting from the engagement in the interactive activity are likely coarse and inaccurate.

FIG. 1 shows an assessment process according to the prior art. As illustrated, the assessment data is acquired using indirect and subjective assessments (e.g., a questionnaire) after the completion of the interactive activity. Information from these indirect and subjective assessments are used to optimize the different aspects of a subsequent presentation of the activity.

### SUMMARY OF THE INVENTION

The inventor has recognized that it is desirable to more directly and objectively optimize one or more parameters of interactive activities for a particular purpose, and to do so even during the interactive activity. Such a purpose can be, for example, to maximize the level of enjoyment of a person playing a computer game. The optimization of the activity that results from prior art measurements is not applicable for such an application. In consequence, an embodiment provides a solution for producing real time assessment data that can be the basis for optimizations of the interactive activity in a direct and objective fashion.

Aspects of the invention provide a solution for adjusting an interactive activity. While a person is engaged in an instance of the interactive activity, direct measurement data corresponding to the person is received. The direct measurement data is used to assess at least one aspect of a response of the person to the instance of the interactive activity. Assessment data corresponding to the at least one aspect of the response is provided for use in adjusting at least one aspect of the interactive activity.

A first aspect of the invention provides a computer-implemented method comprising: receiving direct measurement data corresponding to a person while the person is engaged in an instance of an interactive activity on a computer system; assessing, by the computer system, at least one aspect of a response of the person to the instance of the interactive activity using the direct measurement data; and providing assessment data corresponding to the at least one aspect of the response for use in adjusting at least one aspect of the interactive activity.

A second aspect of the invention provides a computer system comprising: a set of computing devices for performing a method including: receiving direct measurement data corresponding to a person while the person is engaged in an instance of an interactive activity; assessing at least one aspect of a response of the person to the instance of the interactive activity using the direct measurement data; and providing assessment data corresponding to the at least one aspect of the response for use in adjusting at least one aspect of the interactive activity.

A third aspect of the invention provides a computer-readable storage device storing program code, which when executed, enables a computer system to implement a method, the method including: receiving direct measurement data corresponding to a person while the person is engaged in an instance of an interactive activity; assessing at least one aspect of a response of the person to the instance of the interactive activity using the direct measurement data; and providing assessment data corresponding to the at least one aspect of the response for use in adjusting at least one aspect of the interactive activity.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an assessment process according to the prior art.

FIG. 2 shows an assessment process according to an embodiment.

FIG. 3 shows an illustrative environment for assessing a person during an interactive activity according to an embodiment.

FIG. 4 shows an illustrative implementation of the computer system according to an embodiment.

FIG. 5 shows an illustrative engagement index as a function of different stages in a game, which was generated from exemplary results from fifteen people, according to an embodiment.

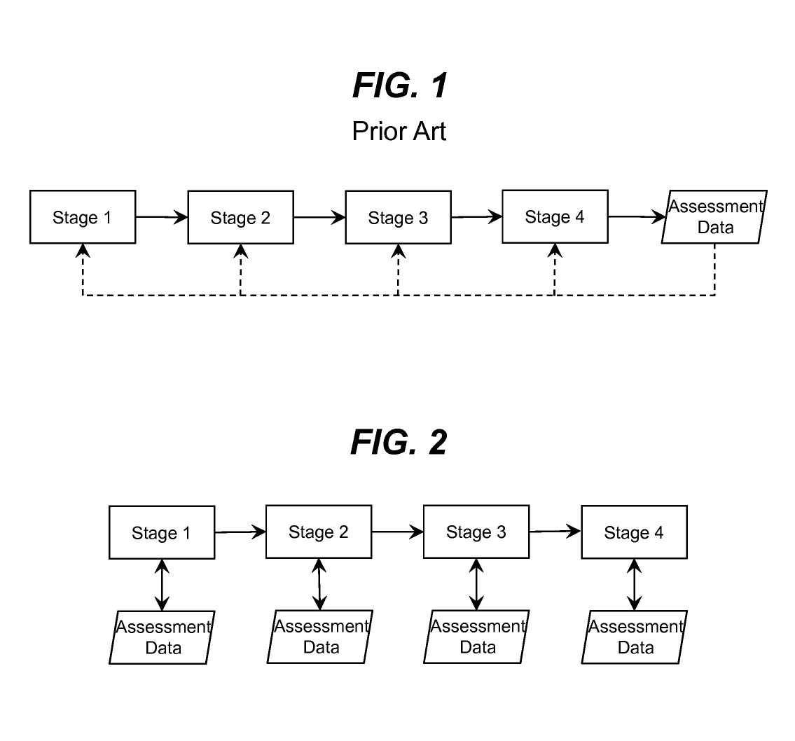

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for adjusting an interactive activity. While a person is engaged in an instance of the interactive activity, direct measurement data corresponding to the person is received. The direct measurement data is used to assess at least one aspect of a response of the person to the instance of the interactive activity. Assessment data corresponding to the at least one aspect of the response is provided for use in adjusting at least one aspect of the interactive activity. As used herein, unless otherwise noted, the term “set” means one or more (i.e., at least one) and the phrase “any solution” means any now known or later developed solution.

As discussed herein, aspects of the invention are directed to interactive activities. As used herein, an interactive activity is an activity in which one or more individuals participate in the presentation of an instance of the activity by providing data, which is used in the management of an instance of the interactive activity. The active participation can affect one or more aspects of the presentation of the instance of the interactive activity to the individual(s), e.g., by providing immediate results (e.g., changes to the presentation) or updated information in response to the act(s) performed by the individual. For example, an interactive activity can be a computer game, in which physical gestures of the individual provide data (e.g., via a controller, as captured by a video and/or audio recording device, and/or the like), which can affect one or more aspects of the computer game as it progresses. Additionally, an interactive activity can be a set of problems presented to one or more individuals, which requires analysis by the individual(s) and feedback provided by the individuals prior to proceeding to another problem (although such feedback can be required to be received within a certain amount of time).

The direct and objective process described herein can assess a person's response to the engagement in an instance of the interactive activity using interpretations of different types of measurements that are made directly from the person engaged in the instance of the interactive activity. These assessments are available in real time at any time during the engagement in the instance of the interactive activity. To this extent, the assessments can be provided as inputs and used to dynamically alter at least one aspect of the instance of the interactive activity.

Turning to the drawings, FIG. 2 shows an assessment process according to an embodiment. As illustrated, objective and direct assessments of one or more aspects of a response of the person to the interactive activity can be made using measurements of the person acquired during the interactive activity. One or more optimizations of the interactive activity can be performed during (e.g., dynamically altering the particular instance of the interactive activity) or after (e.g., evaluating an actual response with a target response) the instance of the interactive activity based on the assessment data. In an embodiment, an optimization includes using the assessment data to determine which of several activities (interactive or non-interactive) or stages of an activity to present in the future. An illustrative non-interactive activity includes the presentation of one or more musical performances, or the like, which can be evaluated and optimized to elicit a target response of the person or a group of people.

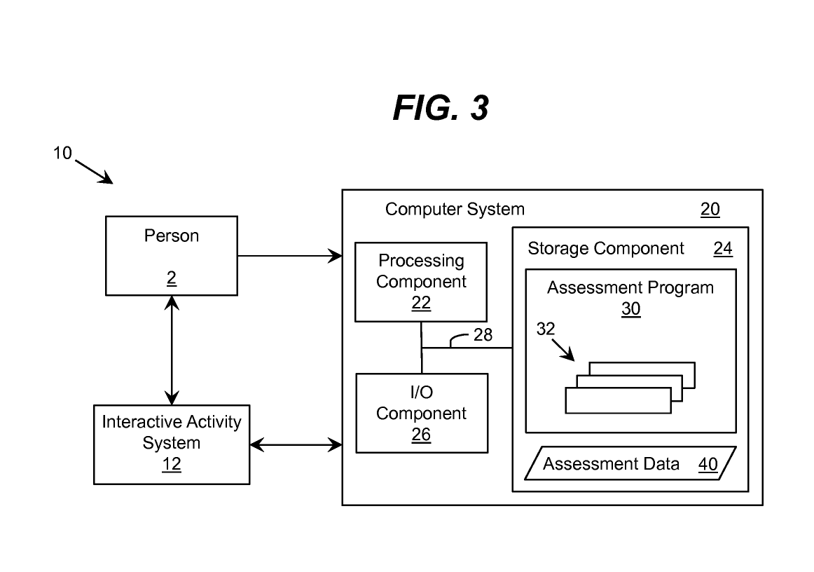

FIG. 3 shows an illustrative environment 10 for assessing a person 2 during an interactive activity according to an embodiment. To this extent, the environment 10 includes a computer system 20 that can perform a process described herein in order to assess the person 2 during his/her engagement with an instance of the interactive activity being managed by an interactive activity system 12. In particular, the computer system 20 is shown including an assessment program 30, which makes the computer system 20 operable to assess the person during the interactive activity by performing a process described herein.

The computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, the processing component 22 executes program code, such as the assessment program 30, which is at least partially fixed in the storage component 24. While executing program code, the processing component 22 can process data, which can result in reading and/or writing transformed data from/to the storage component 24 and/or the I/O component 26 for further processing. The pathway 28 provides a communications link between each of the components in the computer system 20. The I/O component 26 can comprise one or more human I/O devices, which enable a human user (not shown) to interact with the computer system 20 and/or one or more communications devices to enable a system user, such as the interactive activity system 12, to communicate with the computer system 20 using any type of communications link. To this extent, the assessment program 30 can manage a set of interfaces (e.g., graphical user interface(s), application program interface, and/or the like) that enable human and/or system users to interact with the assessment program 30. Furthermore, the assessment program 30 can manage (e.g., store, retrieve, create, manipulate, organize, present, etc.) the data, such as the assessment data 40, using any solution.

In any event, the computer system 20 can comprise one or more general purpose computing articles of manufacture (e.g., computing devices) capable of executing program code, such as the assessment program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the assessment program 30 can be embodied as any combination of system software and/or application software.

Furthermore, the assessment program 30 can be implemented using a set of modules 32. In this case, a module 32 can enable the computer system 20 to perform a set of tasks used by the assessment program 30, and can be separately developed and/or implemented apart from other portions of the assessment program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Additionally, it is understood that some of the functionality discussed herein may not be implemented or additional functionality may be included as part of the computer system 20.

When the computer system 20 comprises multiple computing devices, each computing device can have only a portion of the assessment program 30 fixed thereon (e.g., one or more modules 32). However, it is understood that the computer system 20 and the assessment program 30 are only representative of various possible equivalent computer systems that may perform a process described herein. To this extent, in other embodiments, the functionality provided by the computer system 20 and the assessment program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 20 includes multiple computing devices, the computing devices can communicate over any type of communications link. Furthermore, while performing a process described herein, the computer system 20 can communicate with one or more other computer systems, such as the interactive activity system 12, using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, the assessment program 30 enables computer system 20 to assess the person 2 while he/she is engaged with an instance of an interactive activity. The assessment can be utilized by the interactive activity system 12 to dynamically adjust one or more aspects of the instance of the interactive activity in real time. In this manner, the assessment can comprise an additional input to the interactive activity system 12 for use in managing (e.g., adjusting) one or more aspects of the instance of the interactive activity, supplementing traditional inputs, such as controller movement, physical gestures, and/or the like.

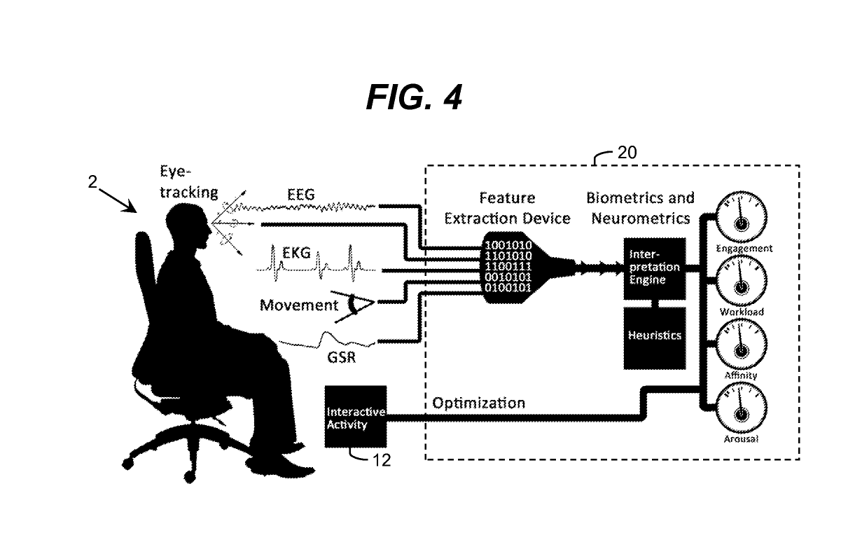

FIG. 4 shows an illustrative implementation of the computer system 20 according to an embodiment. Further illustrative aspects of the invention are described with reference to FIG. 4. The measurements from the person 2 can be acquired by the computer system 20 using one or more traditional survey instruments. More specifically, the measurements can include measurements of the internal state of the person 2 (e.g., electrical, magnetic, metabolic, or optical recordings from or around the brain, muscles, eyes, or heart), measurements of the external (e.g., behavioral) state of the person 2 (e.g., video or audio recordings, measurement of limb/joint torque, force, angle, velocity or position), measurements from the environment (e.g., lighting intensity or color, ambient noise, sounds that are related or unrelated to the activity, etc.), and/or the like. Examples of these recordings include scalp-recorded electroencephalogram (EEG), functional magnetic resonance imaging (fMRI), galvanic skin response (GSR), pupillary dilation, facial movements or expressions, sound recordings, video recordings, measurements from motion capture devices, and/or the like.

These measurements are provided to a Feature Extraction Device of the computer system 20. The Feature Extraction Device synchronizes these measurements with each other and with events during the interactive activity and also extracts informative metrics from these measurements (e.g., biometrics and neurometrics). Biometrics can include the heart rate, skin conductance, parameters of eye movements such as eye gaze direction, eye movement speed or frequency, size of the pupil, and/or the like. Neurometrics can include measurements of blood oxygenation (e.g., blood oxygen level-dependent (BOLD) response), amplitudes in particular frequency bands, time-domain amplitudes, estimates of the relationship between such measurements (e.g., derived using methods such as coherence, covariance, mutual information, partial directed coherence, Granger causality, etc.), and/or the like. These bio/neurometrics can be derived from the calculation of the phase or amplitude of brain signals in different representational domains, such as the frequency domain using procedures such as the fast Fourier transform (FFT), Hilbert transform, bandpass filtering, wavelets, and/or the like, at different frequency bands (e.g., alpha (8-12 Hz), beta (18-25 Hz), gamma (70-170 Hz), theta (4-8 Hz), or other frequencies), or in the time domain, and can be assessed at one or more locations. Extraction of such measurements can benefit from application of signal decomposition techniques (such as principal component analysis (PCA), independent component analysis (ICA), common spatial patterns (CSP)), of modeling techniques (autoregressive (AR) modeling, latent space modeling, dynamic Bayesian networks, etc.), or of filtering techniques (e.g., high/low/bandpass filtering, wavelets, Wiener filtering, optimal filtering, and/or Kalman filtering).

Bio/Neurometrics can be related to a particular time before, during, or after an event of the interactive activity (e.g., a stage of the interactive activity, a particular occurrence/transition/phase of a stage, and/or the like) during the interactive activity. Events can include those that are external to the person 2, illustrative external event include, for example, particular visual or auditory or other stimuli, particular stages of the activity (e.g., particular rooms in computer games), times during the activity that share a particular feature (e.g., times with a particular difficulty during a test, all times in which the computer game features a particular enemy, etc.), or other aspects of the interactive activity. Events also can be defined as events that are internal to the person 2, such as movements of a particular type by the person 2.

The bio/neurometrics resulting from the Feature Extraction Device are combined by an Interpretation Engine to predict a set of emotional or other aspects of the person's 2 state that results from the engagement with the instance of the interactive activity. This combination can make use of one or more classification techniques (e.g., linear discriminant analysis (LDA), support vector machines (SVM), neural networks, and/or the like), clustering/modeling techniques (e.g., k-means, expectation maximization (EM) algorithm, radial basis networks), and/or the like. The emotional aspects extracted from the Interpretation Engine can include, but are not limited to, drowsiness, workload, frustration, anxiety, emotional propensity, level of attention, engagement, positive/negative valence, enjoyment, purchasing decisions, aspects of previous exposures of that activity, etc. The capacity of the Interpretation Engine to make these predictions can benefit from Heuristics. The heuristics can be derived from the establishment of and comparison with a normative database from many people engaged in the interactive activity, from application of appropriate mathematical principles (e.g., combine particular bio/neurometrics using particular equations), or from existing understanding about the nature of the particular bio/neurometric, or the relationship between particular neurometrics. As an example, the variability of the heart rate bears some relationship with the workload a person 2 is experiencing.

In particular embodiments, interactive activities can include playing computer games or solving problems (e.g., mathematical tests, cognitive/motor skill assessment tests). The computer system 20 can generate assessment data corresponding to one or more aspects of the person's 2 cognitive and/or emotional state, which can be provided to the interactive activity system 12 for use in managing (e.g., generating, adjusting, and/or the like) the interactive activity. In particular, the assessment data can be processed as an additional input to the interactive activity system 12, which can result in one or more modifications to the instance of the interactive activity, e.g., to increase/optimize one or more aspects of the person's 2 cognitive and/or emotional state, to match a level of interactivity/difficulty to match the person's cognitive and/or emotional state, and/or the like.

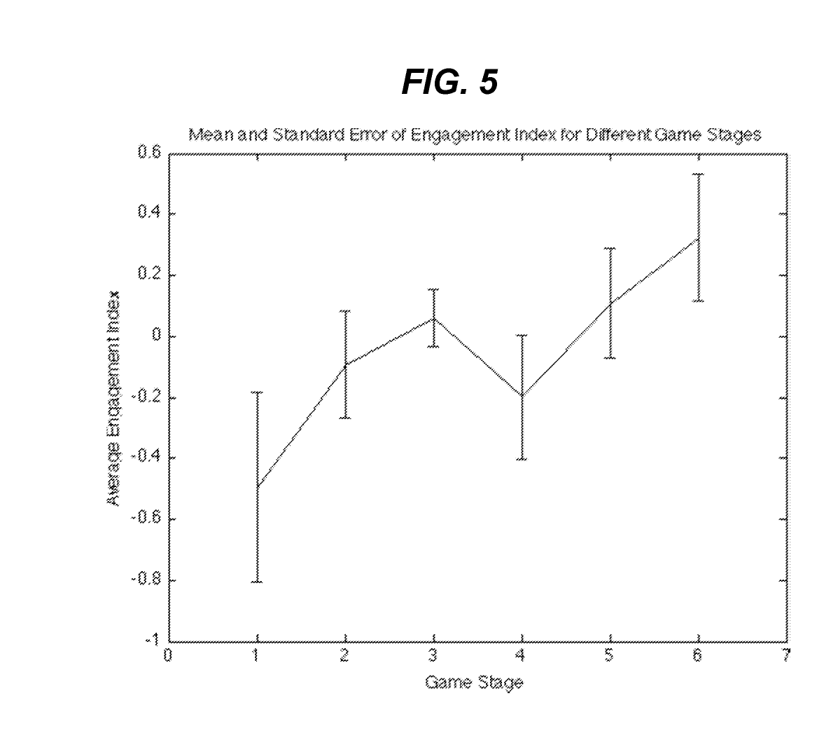

In an illustrative embodiment, a person 2 is playing a computer game managed by interactive activity system 12 while measurements of brain signals, eye movements, galvanic skin response, and other measurements are being made by the computer system 20. These measurements are being assessed during the computer game by the computer system 20. Using particular heuristics, the computer system 20 derives predictions of the level of the person's 2 engagement or enjoyment during the computer game at particular time periods throughout the game (see, e.g., FIG. 5). In an embodiment, these predictions are used to optimize the design of the game. For example, the predictions can be provided to the interactive activity system 12 for use in adjusting one or more aspects of a future instance of the computer game. An adjustment can include determining which of several possible activities/stages of the computer game to present in future presentations of the computer game and/or which of several possible computer games to present in the future.

In another illustrative embodiment, these predictions are used by the interactive activity system 12 to optimize the execution of the game during game play, e.g., optimize the level of difficulty of the game, optimize the game's user interface, etc.

In another illustrative embodiment, predictions are made from many people who engage in the interactive activity at once. These predictions are then used by the interactive activity system 12 to optimize the interactive activity, or to draw conclusions about the collective characteristics of the people or the characteristics of an individual person 2. Optimizations can include dynamic changes to the instance of the interactive activity, changes to future presentations of the interactive activity, selection of one of several possible interactive activities, and/or the like.

In another illustrative embodiment, a person 2 is subjected to a computer-based assessment battery (e.g., proficiency test) generated by the interactive activity system 12. Predictions of the subject's cognitive state can be generated by the computer system 20 and used by the interactive activity system 12 to optimize one or more of the characteristics of the assessment battery. Illustrative optimizations can include changes to future presentations of the assessment battery, selection of one of several possible assessment batteries to use, and/or the like.

In another illustrative embodiment, a person 2 is subjected to a computer-based assessment battery (e.g., a proficiency test) generated by the interactive activity system 12. Predictions of the subject's cognitive state are generated by the computer system 20 and used by the interactive activity system 12 to optimize the assessment battery while the person 2 is interacting with the assessment battery. For example, the interactive activity system 12 can adapt the level of difficulty of the questions by predictions of workload.

While shown and described herein as a method and system for assessing a person during an interactive activity, it is understood that aspects of the invention further provide various alternative embodiments. For example, in one embodiment, the invention provides a computer program fixed in at least one computer-readable medium, which when executed, enables a computer system to assess a person during an interactive activity. To this extent, the computer-readable medium includes program code, such as the assessment program 30 (FIG. 3), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as the assessment program 30 (FIG. 3), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for assessing a person during an interactive activity. In this case, a computer system, such as the computer system 20 (FIG. 3), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method comprising:
receiving direct measurement data corresponding to a person while the person is engaged in an instance of an interactive activity on a computer system;
assessing, by the computer system, at least one aspect of a response of the person to the instance of the interactive activity using the direct measurement data; and
providing assessment data corresponding to the at least one aspect of the response for use in adjusting at least one aspect of the interactive activity.

2. The method of claim 1, wherein the providing includes providing the assessment data as an input for use by an interactive activity system managing the instance of the interactive activity.

3. The method of claim 2, further comprising the interactive activity system altering at least one aspect of the instance of the interactive activity in response to the assessment data.

4. The method of claim 1, wherein the providing includes providing the assessment data for use by a development system for the interactive activity, wherein the development system adjusts at least one aspect of a future instance of the interactive activity using the assessment data.

5. The method of claim 1, wherein the direct measurement data includes data corresponding to an internal state of the person.

6. The method of claim 5, wherein the data corresponding to the internal state of the person includes a recording corresponding to at least one of: the brain, the muscles, the eyes, or the heart of the person.

7. The method of claim 1, wherein the direct measurement data includes data corresponding to an external state of the person.

8. The method of claim 1, further comprising receiving environment measurement data corresponding to at least one aspect of an environment within which the person is located, wherein the assessing further uses the environment measurement data.

9. The method of claim 1, wherein the assessing includes synchronizing the direct measurement data with at least one event of the interactive activity.

10. The method of claim 1, wherein the assessing includes generating a prediction of at least one of: a cognitive state or an emotional state of the person resulting from the engagement of the person in the instance of the interactive activity.

11. A computer system comprising:
a set of computing devices for performing a method including:
receiving direct measurement data corresponding to a person while the person is engaged in an instance of an interactive activity;
assessing at least one aspect of a response of the person to the instance of the interactive activity using the direct measurement data; and
providing assessment data corresponding to the at least one aspect of the response for use in adjusting at least one aspect of the interactive activity.

12. The system of claim 11, wherein the providing includes providing the assessment data as an input for use while managing the instance of the interactive activity.

13. The system of claim 12, the method further comprising altering at least one aspect of the instance of the interactive activity in response to the assessment data.

14. The system of claim 11, wherein the direct measurement data includes data corresponding to an internal state of the person.

15. The system of claim 11, wherein the direct measurement data includes data corresponding to an external state of the person.

16. The system of claim 11, the method further including receiving environment measurement data corresponding to at least one aspect of an environment within which the person is located, wherein the assessing further uses the environment measurement data.

17. The system of claim 11, wherein the assessing includes synchronizing the direct measurement data with at least one event of the interactive activity.

18. The system of claim 11, wherein the assessing includes generating a prediction of at least one of: a cognitive state or an emotional state of the person resulting from the engagement of the person in the instance of the interactive activity.

19. A computer-readable storage device storing program code, which when executed, enables a computer system to implement a method, the method including:
receiving direct measurement data corresponding to a person while the person is engaged in an instance of an interactive activity;
assessing at least one aspect of a response of the person to the instance of the interactive activity using the direct measurement data; and
providing assessment data corresponding to the at least one aspect of the response for use in adjusting at least one aspect of the interactive activity.

20. The storage device of claim 19, wherein the providing includes providing the assessment data as an input for use by a system managing the instance of the interactive activity, the method further including altering at least one aspect of the instance of the interactive activity in response to the assessment data.
